(19) United States
(12) Patent Application Publication
(10) Pub. No.: US 2005/0228844 A1
(43) Pub. Date: Oct. 13, 2005

(54) Fast operand formatting for a high performance multiply-add floating point-unit

(75) Inventors: Sang H. Dhong, Austin, TX (US); Silvia M. Mueller, St. Ingbert (DE); Hiroo Nishikawa, Kusatsu-shi (JP); Hwa-Joon Oh, Austin, TX (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 10/821,606

(22) Filed: Apr. 8, 2004

(51) Int. Cl. G06F 7/38

(52) U.S. Cl. 708/501

(57) ABSTRACT

Disclosed are a floating point execution unit, and a method of operating a floating point unit, to perform multiply/add operations using a plurality of operands from an instruction having a plurality of operand positions. The floating point unit comprises a multiplier for calculating a product of two of the operands, and an aligner for combining said product and a third of the operands. A first data path is used to supply to the multiplier operands from a first and a second of the operand positions of the instruction, and a second data path is used to supply the third operand to the aligner. The floating point unit further comprises a multiplexer on the second data path for selecting, for use by the aligner, either the operand from the second operand position or the operand from the third operand position of the instruction.

### BACKGROUND OF THE INVENTION

1. Field of the Invention

This invention generally relates to high speed data processing systems, and more specifically, to a floating point execution unit.

2. Background Art

High speed data processing systems typically are provided with high-speed floating point units (FPUs) that perform floating point operations such as add, subtract, multiply, and multiply/add. These systems typically utilize a pipelined architecture providing for a multistaged data flow that is controlled at each stage by control logic. This architecture allows multiple instructions to be processed concurrently in the pipeline.

Floating point numbers, as defined, for example, in a standard IEEE format, are comprised of a digit and a decimal point followed by a certain number of significant digits, for example, 52, multiplied by 2 to a power. For example, a floating point number can be expressed as +(1.0110 . . . . )*(2^{χ}). Consequently, floating point numbers are represented by a sign, a mantissa and an exponent. A mantissa is the digit and binary point followed by the significant digits. The mantissa may have, for instance, a total of 53 significant digits. The exponent is the power to which 2 is taken.

Mathematical operations on floating point numbers can be carried out by a computer. One such operation is the multiply/add operation. The multiply/add operation calculates Ra*Rc+Rb, where Ra, Rb and Rc are floating point operands.

Multiply-add based floating point units process operations with two and three operands. Two-operand instructions are A+B, A−B and A*B, and common three-operand instructions are A*B+C, A*B−C, C−A*B and −A*B−C. Thus, the FPU always gets three operands and in an operand formatting step, has to select the operands used by the current instruction. During this step, the FPU also unpacks the operands, i.e., it extracts sign, exponent and mantissa (s,e,m) from the packed IEEE floating point format and extracts information about special values NAN, Infinity and Zero.

Some designs perform the unpacking/packing during a memory access. While having a special unpacked format in the register file speeds up the execution of FPU operations, it also has some drawbacks. The FPU requires its own register file, and forwarding data between the FPU and other units (e.g., fixed point units, branch units) becomes a memory store/load operation, causing a performance penalty for this kind of result forwarding. However, this only addresses the delay due to unpacking the packed IEEE data, but it does not address the performance penalty, which is due to the operand selection.

### SUMMARY OF THE INVENTION

An object of this invention is to increase the performance speed of a floating point execution unit.

Another object of the invention is, in the common case of the operation of a floating point unit, to remove the operand formatting/selection and unpacking step from the timing critical path, increasing the performance of the floating point unit significantly.

These and other objectives are attained with a floating point execution unit, and a method of operating a floating point unit, to perform multiply/add operations using a plurality of operands taken from an instruction having a plurality of operand positions. The floating point unit comprises a multiplier for calculating a product of two of the operands, and an aligner coupled to the multiplier for combining said product and a third of the operands. A first data path is used to supply to the multiplier operands from a first and a second of the operand positions of the instruction, and a second data path is used to supply the third operand to the aligner. The floating point unit further comprises a multiplexer on the second data path for selecting, for use by the aligner, either the operand from the second operand position of the instruction or the operand from the third operand position of the instruction.

The preferred embodiment of the invention implements a number of specific features relating to instruction format, operand muxing, and fast unpacking and late correction for special operands.

More specifically, the operands of the two- and three-operand instructions are assigned in a specific way to the operand fields in the instruction word, so that the operand muxing only occurs in the aligner and exponent logic but not in the multiplier. This speeds up the multiplier path without additional delay for the aligner and exponent path. In addition, the operand muxing in the aligner is merged with the shift-amount calculation (exponent path) such that it does not add to the latency of the design. This speeds up the aligner paths. Also, for normalized operands, the unpacking of the floating point number is completely removed from the timing critical path.

Since unpacking and packing is performed by the FPU, the FPU can share the register file with other units, and non-arithmetical FPU operations, like compares and absolute value, can be easily and efficiently executed in the fixed-point unit. The result forwarding between the FPU and other units can be done without additional penalty for packing or unpacking.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 depicts the main data flow of the fraction data path of a floating point unit for a multiply-add operation.

FIGS. 2 and 3 show two different schemes for assigning the operand fields of an instruction word to a multiplier and an aligner of the floating point unit.

FIGS. 4 and 5 illustrate two procedures for computing a shift amount for the aligner of the floating point unit.

FIG. 6 diagrammatically shows a shift alignment procedure in a floating point unit.

FIG. 7 is a block level diagram of an aligner in a floating point unit with late zero correction.

### DETAILED DESCRIPTION OF THE PREFERRED EMBODIMENTS OF THE INVENTION

The present invention relates to an improvement in the speed at which a multiply/add instruction is carried out. The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

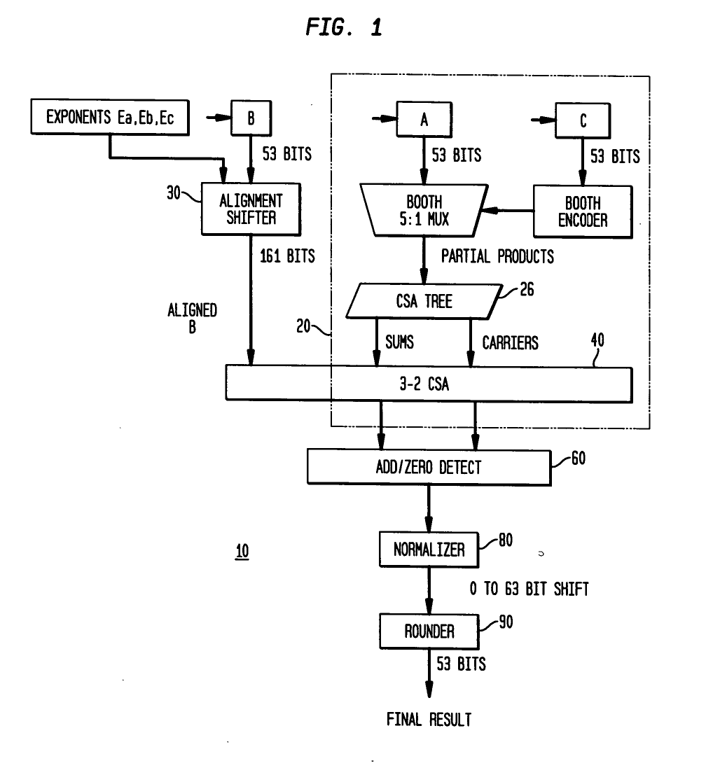

FIG. 1 is a flow chart of how a multiply/add operation is performed in the main data path of a conventional FPU. Note that in the present context, an add is defined to be either an add or a subtract. In the example of FIG. 1, the mantissas are each 53 bits wide. FIG. 1 shows the main data path 10 of a conventional floating point unit having as inputs the mantissas A, B, and C and the exponents Ea, Eb and Ec of operands Ra, Rb and Rc, respectively. The partial product of (A)*(C) emerges at the output of Carry Save Adder (CSA) tree 26.

In order to add the addend Rb to the product Ra*Rc, the mantissas of Rb and Ra*Rc must be expressed relative to the same exponent; i.e., the mantissas of Rb and Ra*Rc must get aligned. Thus, the alignment shifter shifts the mantissa of Rb by the exponent difference of the product and addend. At the same time that A and C are routed to the multiplier path 20, B and the exponents Ea, Eb and Ec are routed to alignment shifter 30. In a typical embodiment, alignment shift and multiplication are performed in parallel to increase the speed of the multiply-add.

The shifted B, and the sums and carries from CSA tree 26 are then input to 3-2 CSA 40. The output of CSA 40 is then input to unit 50, which carries out the operation B+A)*(C). Leading zeroes in the mantissa of the resultant are detected by unit 50, and the resultant input is applied to normalizer 80. Normalizer 80 shifts the mantissa of the resultant left to remove any leading zeroes. A rounder 90 may be provided to round off the resultant value, and Rounder 90 can also be used to force special results, such as not-a-number (NAN), infinity, or zero.

The preferred embodiment of the invention implements a number of specific features relating to instruction format, operand muxing, and fast unpacking and late correction for special operands in order to increase the speed of the FPU. Each of these features is discussed in detail below.

Operand Order/Instruction Format

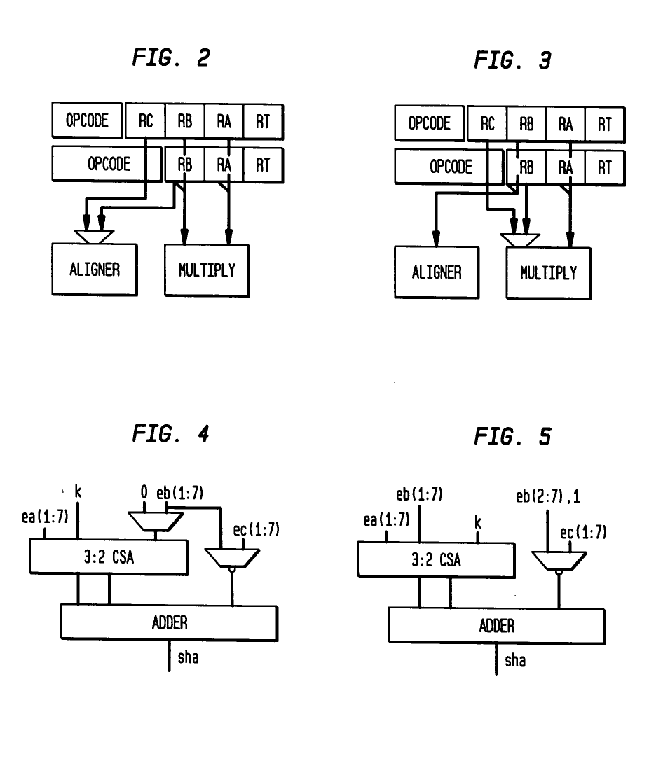

The FPU executes two-operand and three-operand instructions; each of these instructions uses the multiplier and the aligner. In most instruction set architectures, the opcodes for three-operand instructions are limited, so that the two-operand FPU instructions cannot be assigned to these kinds of formats. As a result, as shown in FIGS. 2 and 3, one ends up with one of two operand assignments:
FMA: T=A*B+C FA: T=A+B(=A*1.0+B) FM: T=A*B(=A*B+0.0) i)
FMA: T=A*C+B FA: T=A+B(=A*1.0+B) FM: T=A*B(=A*B+0.0). ii)

The Add is typically executed as A*1.0+B and the Multiply as A*B+0.0. Thus, with either type of operand assignment, there is some muxing required in order to obtain the proper inputs for the multiplier and aligner.

With the format of FIG. 3, the multiplier either computes A*B or A*C and therefore needs a multiplexer on one of its operands. Even for Booth multipliers, both inputs are equally time critical, so that the mux adds to the overall delay of the multiplier, if it is not done in a formator stage. The addend can always be selected as B.

The preferred embodiment of this invention uses the format of FIG. 2. With this format, the multiplier always computes A*B; no muxing of operands is needed. The aligner now gets either C or B and therefore requires some muxing. Multiplier and aligner are equally time critical.

With the preferred scheme of FIG. 2, the time critical path is in the shift-amount computation (exponents), and not on the fraction part of the aligner. Thus, we can add the mux on the aligner fraction part without any performance penalty. The alignment shift amount is only needed for add and multiply-add type instructions, not for multiply. In this format, it is computed as:
For adds: shif_amount=ea−eb+K
For multiply-add: shift_amount=ea+eb−ec+K,

where K is a constant. Thus, with reference to FIGS. 4 and 5, with either coding, the shift amount computation needs some muxing of the input exponent, as indicated in the conventional design shown in FIG. 4. It may be noted that eb=2eb−eb, and that 2eb can easily be obtained by shifting eb one bit to the left. Consequently, the shift amount for add operations can be expressed as:
For adds: shift_{—}amount=ea−eb+K=ea+eb−2eb+K.

In the improved design of this invention, as illustrated in FIG. 5, the exponent muxing is done in parallel to the 3:2 compression. This feature, together with the different operand assignment and the fast unpacking, discussed below, enables the preferred embodiment of the present invention to hide the formatting completely for floating point multiply add type instructions.

The preferred formatting procedure of this invention has a number of advantages. The standard multiplier implementation is a Booth reduction tree, where one operand gets re-coded and the other operand gets amplified because it has many sinks. Both paths tend to be equally time critical. Thus, a muxing on either of the operands adds to the latency of the multiplier, causing a performance penalty. One advantage of the preferred implementation of this invention is that no operand muxing on the multiplier is needed.

Another advantage is that the aligner starts with computing the shift amount, which is only based on the exponent values. No matter whether we use the scheme of FIG. 2 or the scheme of FIG. 3, the shift amount calculation requires some muxing. The shift amount is then used to shift/align the fraction of the addend. Thus, wile computing the shift amount, there is enough time to select between fraction B, C and 0.

Thus, using the scheme of FIG. 2 removes the operand muxing from the multiplier path and moves it to the fraction path of the aligner without increasing the aligner latency. The only operand muxing that is still on the timing critical path is in the shift amount calculation. This is addressed by the procedure discussed immediately below.

Merged Operand Selection and Shift Amount Calculation

The alignment shifter aligns the addend and the product by right shifting the addend. The shift amount is computed, assuming a pre-shift to the left by shift_offset, to account for an addend which is larger than the product. This pre-shift only goes into the shift-amount calculation but does not require any actual shifting on the fraction. The shift amount equals:
A*B+C: sha=ea+eb−ec+shift_offset−bias
A+B sha=ea−eb+shift_{—}offset.

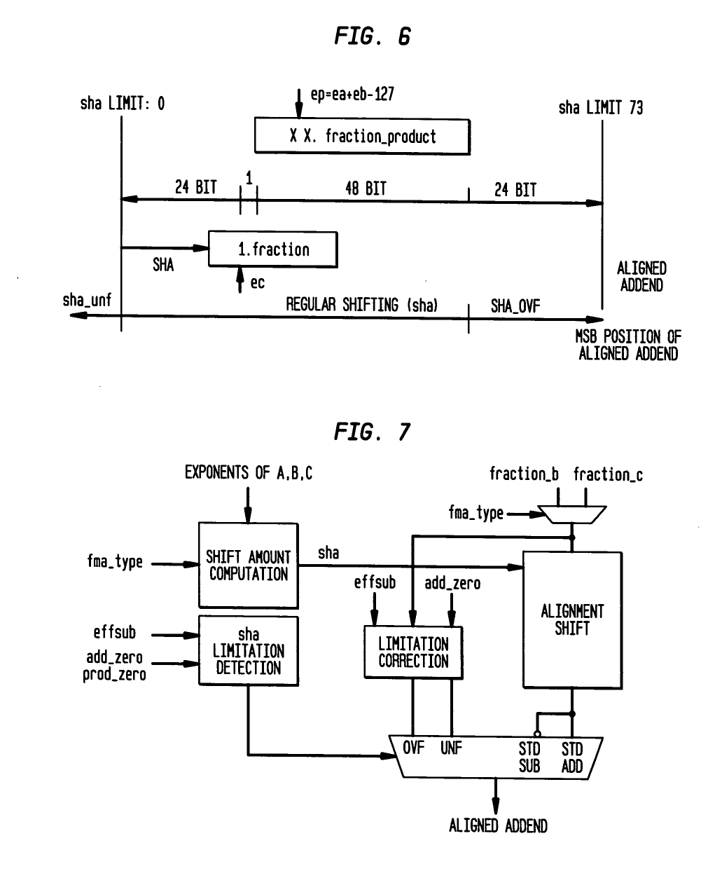

The range of this shift amount is way too large for implementation purposes: for single precision, it is in the range of 0 . . . 3000. Thus, it is common practice to saturate the shift amount to a maximal number of 4n+x, where n is the precision of the fiaction (24 for single precision) and x is usually 1, 2 or 3. FIG. 6 shows one possible shift limitation for a single precision aligner.

The common approach is to first select the exponents and then start the shift amount calculation. Thus, the muxing of the operands is on the critical path of the aligner path.

The preferred embodiment of this invention, and as illustrated in FIG. 5, selects the exponents in parallel with a first part of the shift amount computation. For single precision, this merging is as follows:

$$\begin{matrix}Sha = ea - eb + shift\_offset = ea + eb - 2 eb + shift\_offset \\ = ( ea + eb - 2 eb + shift\_offset - bias - 1 ) mod 128 \\ = ( ( ea + eb - 2 eb - 1 ) + shift\_offset - bias ) mod 128.\end{matrix}$$

With reference to FIG. 5, since the shift amount is limited to a value less than 128, the C operand for the shift amount selection can be chosen as follows:
FA,FS: ec′(1:7)=(eb(2:7),1)<--2eb+1,
Others: ec′(1:7)=ec(1:7).

The mux is faster than the 3:2 reduction stage (cany-save adder). Thus, the delay of the operand selection in the aligner is removed from the critical path. It is completely hidden by the first stage of the shift amount calculation.

This works for any floating-point precision; only the offset, bias and modulo value are different.

Fast Unpacking and Late Correction of Special Operands

Register file floating point data format

All processors with an IEEE compliant FPU store the floating-point data in memory in the packed format, specified in the IEEE standard (sign, exponent, fraction). Some processors already unpack the operands while loading them into the register file, and pack them as part of the store operation. In other designs, the register file still holds the operands in the packed format.

While having a special unpacked format in the register file speeds up the execution of the FPU operations, it also has some drawbacks. Due to the special operand format, the FPU requires its own register file, and forwarding data between the FPU and other units (e.g., fixed-point unit, branch unit) becomes a memory store/load operation, causing a performance penalty for this kind of result forwarding.

When the unpacking and packing is part of the FPU operations, the FPU can share the register file with other units, and non-arithmetical FPU operations, like compares and absolute-value, can be easily and efficiently executed in the fixed-point unit. The result forwarding between the FPU and other units can then be done without additional penalty for packing or unpacking. However, the unpacking of the operands adds latency to each FPU operation. Except for denormal operands, the preferred embodiment of this invention removes this unpacking of the operands from the time critical path.

Handling of Special Values

The goal of the preferred embodiment of this invention is to make the common case fast. The common case operation has normalized or zero operands and produces a normalized or zero result. In most applications, denormalized operands are rare. It is therefore very common practice to handle denormal operands in the following ways:

In a fast execution mode, denormal operands are forced to zero.

In IEEE compliant mode, when denormalized operands are detected, the execution is stalled, the operands are pre-normalized, and the execution is restarted.

NAN and Infinity are operands for which the IEEE standard specifies special computation rules. This computation is much simpler than the one for normalized operands, and can be done on the side in a relatively small circuit. This special result is then muxed into the FPU result in the final result selection and packing step of the rounder.

The main data path of the FPU handles normalized and zero operands at full speed.

The FPU gets the operands in packed IEEE format. In the preferred operation of the invention, the operands are unpacked, i.e., sign, exponent and mantissa are extracted, and special values are detected. The mantissa is m=L.f, where f is the fraction and L is the leading bit. The leading bit L is derived from the exponent value; it is 1 for normalized numbers (exp!=0) and 0 for zero and denorms (exp=0).

In the standard implementation, the exponent is checked for zero. Based on the outcome of that test, the leading bit of the operand is set either to 0 or 1. The mantissa is then sent to the aligner and/or multiplier. Thus, the zero check of the exponent is on the time critical path.

The preferred embodiment of this invention assumes a normalized operand; the leading bit L is already set to 1 during the operand fetch/result forwarding. In parallel to the first multiply and alignment steps, the exponents are tested for zero, producing three bits:

i) Add_zero: this bit indicates that the addend is zero,

ii) Prod_zero: this bit indicates that the product is zero, i.e., that at least one of the multiplier operands is zero.

iii) Result_zero: this bit indicates that the addend and the product are zero; this implies a zero result. However, a zero result can also be obtained from non-zero operands, for example, when computing x-x for a non-zero number x; for these cases, the bit result_zero is off. When addend and product are both zero, the result of the main data paths does not matter. This is also a special case in the IEEE standard.

These three bits are obtained fast enough to be fed in the “shift amount limitation correction logic” of the aligner, discussed below.

Shift Amount Limitation Correction

Shift Amount Overflow

If the shift amount is larger than the shift_limit, then all the bits of the mantissa get shifted into the sticky bit field. In that case, it suffices to force the input mantissa m into the sticky field and to clear all the other bits of the aligned result before possibly inverting the result vector, which is an effective subtraction.

Shift Amount Underflow

For a shift amount of less than 0, an unlimited shift would shift bits out to the left of the result vector. In that case, the input mantissa m is forced into the most significant bits of the aligner result and the remaining bits of the result are cleared before possibly inverting the result. In this case, the product is so much smaller than the addend that the lsb of the addend and the msb of the product are separated by at least one bit (rounding=truncation, two bits are needed to support all four IEEE rounding modes). Thus, in case of an addition, a carry cannot propagate into the addend field, and in case of an effective subtraction with cancellation, there is still enough precision there for a precise rounding.

Correction for Zero Addend

A zero addend is much smaller than the product, and is therefore a special case of the shift amount overflow. The shift-amount-overflow bit is set and the whole aligner result vector is cleared for effective add operations and set to all 1 for effective subtraction. Thus, the inverted add_zero bit is ANDed to the regular overflow correction vector prior to a possible negation for effective subtraction

Correction for Zero Product

A zero product is much smaller than the addend; this is therefore a special case of the shift amount underflow. For truncation rounding, it suffices to force the shift-amount-underflow bit on. For directed rounding (to infinity or to nearest even), the sticky bit is also forced to zero. This can be done by ANDing the sticky bit with the inverted prod_zero bit.

FIG. 7 depicts the block level diagram of the aligner with late zero correction. The timing critical path starts with the shift amount computation and then goes through the alignment shifter and the final muxing (inverting) stage. The limitation correction and late zero correction are off the critical path; that logic is simpler and faster.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A floating point execution unit for performing multiply/add operations using a plurality of operands taken from an instruction having a plurality of operand positions, the floating point unit comprising:
a multiplier for calculating a product of two of the operands;
an aligner coupled to the multiplier for combing said product and a third of the operands;
a first data path for supplying to the multiplier operands from a first and a second of the operand positions of the instruction;
a second data path for supplying the third operand to the aligner; and
a multiplexer on the second data path for selecting, for use by the aligner, either the operand from the second operand position of the instruction or the operand from the third operand position of the instruction.

2. A floating point execution unit according to claim 1, wherein the first data path is maintained free of multiplexer operations.

3. A floating point execution unit according to claim 1, wherein:
the aligner includes means to compute a shift amount for aligning said product and the third operand; and
the multiplexer operates to select the third operand in parallel with the means to compute the shift amount.

4. A floating point execution unit according to claim 3, wherein the multiplexer selects the third operand while the means to compute computes said shift amount.

5. A floating point execution unit according to claim 3, wherein each of the operands and said product includes an exponent value, and the means to compute computes said shift amount based only on said exponent values.

6. A floating point execution unit according to claim 1, wherein each of the operands has an exponent value, and further comprising means, operating in parallel with the multiplier and the aligner, to determine whether the exponent values of any of the operands is zero.

7. A floating point execution unit according to claim 6, wherein said means to determine tests said exponent values for a zero value while the multiplier calculates said product.

8. A floating point execution unit according to claim 6, wherein the means to determine establishes a test result number based on results of said determination.

9. A floating point execution unit according to claim 8, wherein:
the test result number includes a plurality of bits;
a first of the bits indicates whether the addend is zero; and
a second of the bits indicates whether the product is zero.

10. A floating point execution unit according to claim 9, wherein the plurality of bits are used to force special values into the aligner result.

11. A floating point execution unit according to claim 3, wherein the means to compute the shift amount compresses two of the three input exponents and an offset while selecting the third exponent.

12. A floating point execution unit according to claim 11, wherein, when executing an add or subtract instruction, the means to compute the shift amount computes the alignment shift amount as ea+eb−72eb.

13. A method of operating a floating point execution unit to perform multiply/add operations the floating point unit having a multiplier, an aligner coupled to the multiplier, and a multiplexer, the method comprising the steps:
sending an instruction to the floating point unit, the instruction having a plurality of operand positions holding operands;
using the multiplier to calculate a product of two of the operands;
using the aligner to combine said product and a third of the operands;
supplying over a first data path to the multiplier operands from a first and a second of the operand positions of the instruction;
supplying over a second data path the third operand to the aligner; and
positioning the multiplexer on the second data path;
using the multiplexer to select, for use by the aligner, either the operand from the second operand position of the instruction or the operand from the third operand position of the instruction.

14. A method according to claim 13, comprising the further step of maintaining the first data path free of multiplexer operations.

15. A method according to claim 13, comprising the further step of:
using the aligner to compute a shift amount for aligning said product and the third operand;
and wherein the multiplexer operates to select the third operand in parallel with the aligner.

16. A method according to claim 15, wherein the multiplexer selects the third operand while the aligner computes said shift amount.

17. A method according to claim 15, wherein each of the operands and said product includes an exponent value, and the step of using the aligner to compute said shift amount includes the step of computing said shift amount based only on said exponent values.

18. A method according to claim 13, wherein each of the operands has an exponent value, and comprising the further step of, determining, in parallel with the multiplier and the aligner, whether the exponent values of any of the operands is zero.

19. A method according to claim 18, wherein the step of determining whether the exponent values of any of the operands is zero occurs while the multiplier calculates said product.

20. A method according to claim 18, comprising the further steps of:
establishing a test result number based on results of said determination, the test result number including a plurality of bits, using a first of the bits to indicate whether the addend is zero; and
using a second of the bits to indicate whether the product is zero.
